(19) United States
(12) Patent Application Publication
(10) Pub. No.: US 2026/0365504 A1
(43) Pub. Date: Nov. 19, 2026

(54) METHOD AND SYSTEM FOR PROTECTING AN OPERATOR OF AN AERIAL LIFT AGAINST CRUSHING, AND AERIAL LIFT COMPRISING THIS SYSTEM

(71) Applicant: HAULOTTE GROUP, Lorette (FR)

(72) Inventors: Emmanuel Huber, Oullins (FR); Nicolas Bonnefoy, Saint-Chamond (FR); Loïc Commandeur, Echalas (FR); Laurent Muguet, Mornant (FR)

(73) Assignee: HAULOTTE GROUP, Lorette (FR)

(21) Appl. No.: 19/126,057

(22) PCT Filed: Nov. 17, 2023
(86) PCT No.: PCT/IB2023/061633

§ 371 Date: Apr. 30, 2025

(30) Foreign Application Priority Data
Nov. 17, 2022 (FR) 2211986

(51) Int. Cl. B66F 17/00; B66F 11/04

(52) U.S. Cl. CPC B66F 17/006; B66F 11/042

(57) ABSTRACT

The invention relates to a method for protecting an operator O on a work platform 3 of an aerial lift against crushing, in which aerial lift a control console 10 allows the operator to initiate a movement of the work platform 3. The method provides that the movement of the work platform 3 is either stopped or executed at a speed below a normal speed of the movement depending on whether the movement is in progress at the time when a detection system B1, B2 detects the occurrence of a high-risk situation for the operator, or whether the high-risk situation for the operator is detected at the time the movement is initiated using the control console 10. This differentiated processing decreases the number of times the movement of the work platform is unwantedly stopped. This method is carried out automatically by a system on board the aerial lift.

### BACKGROUND OF THE INVENTION

### Field of the Invention

The present invention relates to the field of mobile elevating work platforms (also referred to by the acronym MEWP), also commonly known as aerial lifts. More specifically, the invention proposes a method and a system for protecting an operator on board a work platform of an aerial lift from being crushed, as well as an aerial lift comprising this protection system.

### Brief Description of the Related Art

Aerial lifts are machines designed to enable one or more people to work at a height. To do this, they comprise a work platform designed to accommodate them and possibly also loads such as tools or other equipment, materials such as paint, cement, etc. The work platform comprises a platform surrounded by a guardrail. It is supported by a lifting mechanism which raises it from a lowered position on the aerial lift chassis to a desired working height.

There is a wide variety of aerial lifts available to suit the various desired uses. Thus, different technologies of the lifting mechanism of the work platform are used according to which aerial lifts are generally qualified, e.g. scissor lifts, vertical mast lifts, articulated lifts, telescopic lifts. Depending on the case, the lifting device may comprise a turret pivotally mounted about a vertical axis on the chassis, to enable the orientation of the lifting mechanism and thus of the work platform to be changed with respect to the chassis. Aerial lifts may also be self-propelled, i.e. motorized to enable them to move autonomously on the ground.

The work platform is equipped with a control panel enabling an operator on board the work platform to cause the work platform to move to the desired working position. For this purpose, the control panel is fitted with control members enabling the operator to actuate the lifting mechanism, but also, where relevant, the pivoting of the turret and the movement of the aerial lift on the ground.

The control panel is usually fixed to or at the level of the guardrail and is provided so that the operator stands in front of it when he wishes to manipulate the control members.

In the case of scissor elevators and vertical-mast elevators in particular, the control panel is sometimes designed to be movable by the operator, so that it can be detachably hung at various points on the guardrail, but preferably at a front corner of the guardrail of the work platform. For this purpose, the control panel is generally more compact and lightweight than fixed control panels. The control panel can also be designed so that the operator can hold it with one hand and manipulate its control members with the other, enabling the aerial lift to be controlled from the ground instead of from the work platform. In this case, the control panel is even more compact and lighter.

When the work platform is moved by an operator at the control desk of the work platform, there is a risk of the operator being crushed against the control desk by an external obstacle—such as part of a building, a structure or a tree branch—hitting him from behind or above. The same risk may exist with respect to the guardrail in cases where the operator can stand next to the control panel while manipulating its control members, or in the case of certain movable control panels which are designed so that the operator stands next to the panel rather than in front of it when the panel is hooked onto the guardrail.

Protection systems have been proposed to protect the operator against this risk. Two types of solution are used today.

The first type of protection system consists in fitting a fixed or mobile safety bar in front of the control console, which is interposed between the control console and the operator standing in front of it to manipulate its control members. The control system of the aerial lift stops or prevents the movements of the work platform when the bar is mechanically urged towards the console. This type of solution is illustrated in particular by FR 3 007 401 A1, EP 2 190 775 A1, JP 64-12100, JP H4-77600 U, GB 2 481 709 A1, WO 2017/098120 and WO 2020/144601.

A second type of protection system uses a non-contact detection system to detect an abnormal position of the operator with respect to the control panel or another type of risk situation for the operator. A typical example is the detection of the operator being too close to the control panel, or also possibly too close to the guardrail on one side of the control panel. As in the first type of solution, the operator protection system stops or prevents the movements of the work platform when the detection system detects that the operator is in an abnormal position, in order to avoid the risk of crushing the operator. For example, JP 5-124800 A teaches to place light barriers in front of and above the control console. If the operator is pushed towards the console by an external obstacle, his body cuts off one and/or other of the light beams, in which case the corresponding receiver(s) no longer receive(s) the light from the corresponding beam and consequently the device stops the movements of the aerial lift. WO 2017/178737 proposes an improvement to this system which is based on the detection of an optical beam reflected by the operator instead of the non-reception of the emitted optical beam, which also enables it to be used to detect a proximity of the operator to the guardrail when he is standing on a lateral side of the control console. In another approach, U.S. Pat. No. 10,358,331 B2 proposes the use of a stereoscopic camera with real-time image analysis. This document also proposes the use of an override button to allow slow-speed movement after being stopped or prevented by the protection system. WO 2021/026585 proposes the use of a LIDAR (Light Detection and Ranging) system to detect an abnormal position of the operator and also an abnormal acceleration of the body of the operator.

In addition to these two types of protection system, there are others which use other means for detecting the risk of the operator being crushed in order to inhibit the movements of the work platform, but they are less commonly used.

A common drawback of existing protection systems is to stop or prevent work platform movements if the operator is not sufficiently vigilant and unintentionally triggers the protection system. This is particularly true of the second type of protection system, which uses a non-contact detection system, as the operator does not easily perceive that he may unintentionally trigger the detection. These untimely stoppages result in a loss of productivity. In addition, they can irritate the operator, leading to nervousness and a corresponding drop in vigilance, which is undesirable.

Also known from FR 2 836 468 A1 is an anti-collision system using radar or ultrasonic sensors which measure a distance of the chassis or work platform from an external obstacle. If the measured distance falls below a first threshold, the anti-collision system slows down the speed of displacement of the work platform or chassis, then if the measured distance falls below a second threshold which is smaller than the first threshold, the displacement is inhibited. A more sophisticated approach to this kind of anti-collision protection is also disclosed by U.S. Pat. No. 10,358,331 B2 already mentioned above.

### SUMMARY OF INVENTION

The aim of the present invention is to provide a solution for protecting the operator on board the work platform of aerial lifts that at least partially alleviates the aforementioned drawbacks.

To this end, the present invention proposes a method for protecting an operator on board a work platform of an aerial lift against crushing, which method is implemented automatically, the aerial lift comprising a control panel arranged for use on board the work platform and designed to enable the operator to engage a movement of the work platform, the aerial lift further comprising a detection system for detecting a risk situation for the operator on board the work platform.

The protecting method comprises: implementing a first rule according to which the movement of the work platform is stopped if the movement is in progress at the time when the detection system detects the occurrence of the risk situation for the operator; and implementing a second rule according to which the movement of the work platform is executed at a reduced speed with respect to a normal speed of the movement if the risk situation for the operator is detected by the detection system at the time of engaging the movement at the control desk.

In the method of the invention, the management of the risk situation for the operator is therefore different depending on the circumstances in which it is detected. More specifically, the method involves implementing different management of the risk situation for the operator depending on whether the movement of the work platform is in progress at the time the detection system detects the occurrence of the risk situation for the operator, or whether the risk situation for the operator is detected by the detection system at the time the movement is engaged at the control desk. This different management includes or consists in implementing, depending on the two detection circumstances mentioned, different restriction measures on the operation of the aerial lift. These different measures aim to protect the operator but are adapted to the two detection circumstances mentioned. In short, the same risk situation for the operator is managed either according to the first rule or according to the second rule, depending on whether the condition of the first rule or the condition of the second rule is met.

The condition of the first rule, i.e. whether the movement of the work platform is in progress at the time when the detection system detects the occurrence of the risk situation for the operator, usually corresponds to a significant risk for the operator. This is why the consequence implied by the first rule is to stop the movement of the work platform in order to prevent the operator from being crushed. For this reason, it is preferable for the movement to be stopped immediately, without delay, as soon as the detection system detects the occurrence of the risk situation for the operator.

On the other hand, in the context of the invention, it has been noted that the condition of the second rule, i.e. if the risk situation for the operator is detected by the detection system at the moment the movement is engaged at the control desk, corresponds to a low risk for the operator. In fact, in this case, the risk situation for the operator exists at the very moment when he engages the movement of the work platform. In other words, movement of the work platform engaged by the operator is not the cause of the risk situation. In particular, the operator may have voluntarily placed himself in the risk situation before engaging the movement of the work platform. For example, he may approach the control desk or the guardrail of the work platform at an unusually small distance in order to have a better view of the aerial lift environment before engaging a movement of the work platform.

It is therefore acceptable to authorize the movement of the work platform engaged by the operator when the condition of the second rule is satisfied. However, as provided by the implied consequence of the second rule, it is prudent to authorize the movement only at a reduced speed with respect to a normal speed of the movement applied in normal operation, i.e. when the risk situation for the operator is not detected. In this way, the operator can easily react and manage the risk should a real risk for the operator nevertheless arise after engaging the movement of the work platform. The reduced speed is preferably less than or equal to half the normal speed of the movement concerned, and even more preferably less than or equal to a quarter or even a fifth of the latter. In cases where the speed of the movement concerned can be varied at the control panel by the operator, the maximum value of the normal speed of this movement and the maximum value of the reduced speed of this movement will be taken as a reference for applying this relationship between the reduced speed and the normal speed of the movement.

As the method is implemented automatically, it will be understood that the first and second rules are implemented automatically. In other words, they are applied automatically by the aerial lift without human intervention when the aerial lift is in operation, thus ensuring the effectiveness of the protection method. This also means that in the second rule, the reduced speed is applied automatically by the aerial lift without the operator having to engage a dedicated control for this purpose, such as pressing an override button.

The fact of authorizing the movement engaged at the control desk under the second rule despite the detection of the risk situation advantageously makes it possible to significantly reduce the number of stops and the downtime of the work platform due to the intervention of the anti-crushing protection for the operator, while maintaining an excellent level of anti-crushing protection for the operator. The result is increased productivity. Furthermore, as the implementation of the second rule is automatic, it does not cause any particular annoyance to the operator, as the movement he engages at the control panel is executed immediately without requiring any additional specific action on his part.

The detection system for detecting a risk situation for the operator on board the work platform can be any type of system for detecting a potentially dangerous situation for the operator on board the work platform due to the movement of the latter. Thus, the detection system is preferably designed to detect a risk situation for the operator on board the work platform due to the movement of the work platform. Advantageously, the detection system can be designed to detect a crushing risk situation for the operator on board the work platform. In the latter case, detection is preferably carried out with respect to the body of the operator. In particular, the detection system can be of any type used in prior art operator anti-crush protection systems for aerial lifts. As mentioned, detection can classically be performed with respect to the body of the operator. A number of non-limiting embodiments of the detection system are mentioned below.

According to a preferred embodiment, the risk situation detected by the detection system is a position of the operator with respect to the control panel. Classically, this may involve detecting the proximity of the operator to the front and/or top of the control panel. In other words, the aim is to detect the situation where the operator gets abnormally close to the control panel with respect to the position he normally occupies when using the control panel. For this purpose, prior art systems consisting of mounting a fixed or movable safety bar in front of the control desk can be used to detect a push against it. However, the protection system of the invention is even more interesting in cases where it includes a non-contact detection system, as the risk of detection being triggered unintentionally is greater in this case.

In addition or alternatively, it may involve detecting a remoteness of the operator from the control panel. In other words, the aim in this case is to detect the situation where the operator is abnormally far from the control console with respect to the position he normally occupies when using the control console.

In addition or alternatively, the risk situation detected by the detection system may be the proximity of the operator to a part of the guardrail which is laterally adjacent to the control console. In other words, the aim in this case is to detect the situation where the operator is not standing in front of the control console but is standing abnormally close in front of a part of the guardrail right next to the control console.

According to another preferred embodiment, the risk situation detected by the detection system is the absence of the operator in a given area with respect to the control desk on board the work platform. In other words, the aim is to detect the situation where the operator is outside an area in which he would normally be when using the control console.

In addition or alternatively, it conversely involves detecting the presence of the operator in a specific area with respect to the control panel on board the work platform. In other words, the aim is to detect the situation where the operator is in an area in which he would not normally be when using the control console.

Detection of the presence or absence of the operator in a given area is preferably implemented by non-contact detection.

Although it is advantageously simple and effective to base detection on the position of the operator on board the work platform, or on the presence or absence of the operator in an area on board the work platform, the detection by the risk situation detection system may in other embodiments be based on other physical parameters such as, for example, acceleration of the body of the operator. In particular, it may detect a body acceleration exceeding a given threshold. This detection may be indicative of an obstacle outside the aerial lift colliding with the operator.

In yet another embodiment, the risk situation detected by the detection system may be the proximity of an obstacle external to the aerial lift to the operator on board the work platform. Such detection can also be implemented using non-contact detection.

Generally speaking, the detection system preferably uses non-contact detection, which can be implemented by any suitable technology, for example one or more photoelectric sensors, one or more LIDAR (Light Detection and Ranging) sensors, one or more LADAR (Laser Detection and Ranging) sensors, one or more RADAR (Radio Detection and Ranging) sensors, one or more ultrasound sensors and/or one or more cameras or one or more 3D vision devices with image analysis. However, the detection system can also use contact detection.

According to a preferred embodiment, the method comprises: after triggering of the second rule, executing the movement of the work platform at the reduced speed as long as the movement remains engaged at the control desk, even if the detection system ceases to detect the risk situation for the operator. Triggering of the second rule means that the movement of the work platform is executed at the reduced speed with respect to the normal speed of the movement in application of the second rule, because the risk situation for the operator has been detected by the detection system at the time of engaging this movement at the control desk. Maintaining the movement in progress at the reduced speed despite the cessation of detection of the risk situation for the operator avoids the risk of unbalancing the operator. Indeed, if the speed of the movement of the work platform were to change from reduced speed to normal speed, the operator could become unbalanced due to the acceleration undergone by his body.

According to another preferred embodiment, the method comprises: excluding the application of the first rule when the movement is in progress at the reduced speed; and after triggering the second rule, executing the movement at the reduced speed as long as the movement remains engaged at the control console, regardless of the detection system. Advantageously, this embodiment improves productivity when a movement is in progress at the reduced speed due to the triggering of the second rule. Indeed, if the risk situation for the operator ceases to be detected, then is detected again during the execution of the movement at the reduced speed, the movement in progress of the work platform is not stopped but will continue to continue at reduced speed as long as the movement remains engaged at the control desk. This is acceptable from an operator safety point of view as the operator can easily react and manage the risk if it is real, given that the movement is executed at the reduced speed.

In a preferred embodiment, the method is applied to an ascent movement of the work platform. In other words, the control panel is designed to enable the operator to engage an ascent movement of the work platform, and the method comprises: implementing the first rule according to which the ascent movement of the work platform is stopped if the ascent movement of the work platform is in progress at the time when the detection system detects the occurrence of the risk situation for the operator; and implementing the second rule according to which the ascent movement of the work platform is executed at a reduced speed with respect to a normal speed of the movement if the risk situation for the operator is detected by the detection system at the time of engaging the ascent movement of the work platform at the control desk.

In another preferred embodiment, the method is applied to a movement of the work platform parallel to the ground, which is achieved by translation on the ground of the aerial lift. In this case, the aerial lift is self-propelled to be able to translate on the ground, the control panel being designed to enable the operator to engage a translation on the ground of the aerial lift. And the method comprises: implementing the first rule according to which translation on the ground of the aerial lift is stopped if the translation on the ground of the aerial lift is in progress at the time when the detection system detects the occurrence of the risk situation for the operator; and implementing the second rule according to which the translation on the ground of the aerial lift is executed at a reduced speed with respect to a normal speed of translation on the ground of the aerial lift if the risk situation for the operator is detected by the detection system at the time of engaging the translation on the ground of the aerial lift at the control console.

In this embodiment, the method can also advantageously comprise: implementing the first rule and of the second rule only if the work platform is at least partially raised; and implementing of a third rule according to which the translation on the ground of the aerial lift is authorized regardless of the detection system, on condition that the work platform is in a fully lowered position. The implementation of this third rule is advantageous in terms of productivity, because it avoids the possibility of the aerial lift being stopped on the ground by the protection system. This is acceptable because the operator is then in the situation of a simple motor vehicle driver, since the work platform is completely lowered, it being specified that it is usually foreseen in this case to be able to drive the aerial lift at high speed compared to the normal speed of translation on the ground when the work platform is raised.

According to another preferred embodiment wherein the control panel is designed to enable the operator to selectively engage any one of several different movements of the work platform, the method comprises: excluding at least one movement of the work platform from the implementation of the first rule and of the second rule so as to allow this movement of the work platform regardless of the detection system. In other words, if this movement is engaged at the control desk, it will be executed at its normal speed independently of any detection of the risk situation for the operator. This embodiment is advantageously applicable to any movement considered not to increase the risk for the operator, or even to reduce or eliminate the risk for the operator. The fact of not inhibiting this movement also leads to productivity gains.

This embodiment can advantageously be applied to the descent movement of the work platform. In other words, the control panel is designed to enable the operator to engage a descent movement of the work platform, and the method comprises excluding the descent movement of the work platform from the implementation of the first rule and of the second rule, so as to authorize the descent movement of the work platform regardless of the detection system.

Similarly, this embodiment can also advantageously be applied to the translation on the ground of the aerial lift in forward motion when the aerial lift is self-propelled. In this case, the control panel is designed to allow the operator to engage a translation on the ground of the aerial lift in forward motion, and the method comprises excluding the translation on the ground of the aerial lift in forward motion from the implementation of the first rule and of the second rule so as to authorize the translation on the ground of the aerial lift in forward motion regardless of the detection system. Indeed, the risk of crushing the operator with respect to translating on the ground in forward motion is very low, as the operator naturally looks in the forward direction of the aerial lift in this case and can therefore see a possible external obstacle approaching him. This is even more the case when the control panel is fixedly mounted on the work platform, as the mounting position of the control panel requires the operator to naturally position himself in front of it, looking towards the front of the aerial lift.

According to another preferred embodiment, at least one reset procedure is provided, executable at the control console, and the method comprises: in the event of the first rule being triggered, applying a first restricted operating mode until the reset procedure is executed; and prohibiting the movement throughout the whole time of application of the first restricted operating mode. Triggering of the first rule is understood to mean the case in which the movement of the work platform is stopped in application of the first rule because this movement was in progress at the time when the detection system detected the occurrence of the risk situation for the operator. This prevents the operator from becoming unbalanced due to automatic restart of the movement if detection of the risk situation for the operator ceases after application of the first rule.

According to an advantageous embodiment, the control panel is designed to allow the operator to selectively engage any one of several different movements of the work platform, and the method comprises for each of the movements of the work platform either prohibiting the movement of the work platform to be executed throughout the whole time of application of the first restricted operating mode, or authorizing the movement of the work platform to be executed only at a reduced speed with respect to a normal speed of the movement—preferably regardless of the detection system—throughout the whole time of application of the first restricted operating mode.

Thus, if during the application of the first restricted operating mode, the operator engages a movement of the work platform whose execution is prohibited, this movement will not be carried out by the aerial lift. Such a prohibition is preferably applied to any movement of the work platform which is considered to potentially aggravate the risk of crushing for the operator when a movement in progress of the work platform has just been stopped in application of the first rule. This prevents the operator from aggravating the risk of crushing by accidentally engaging such a movement at the control desk.

On the contrary, the authorization to execute a movement of the work platform but only at reduced speed is preferentially applied to any movement of the work platform that is considered to potentially reduce or eliminate the risk of crushing for the operator when a movement in progress of the work platform has just been stopped in application of the first rule. In this way, the operator can initiate such an authorized movement by engaging it at the control desk in order to free himself from the risk situation. Executing such a movement at reduced speed enables the operator to control it more effectively, and thus to manage safely of this movement of the work platform. For this reason, it is satisfactory to authorize the movement of the work platform to be executed regardless of the detection system, which avoids the operator being hindered by stops to the movement of the work platform due, for example, to a new detection of the risk situation for the operator, since executing the movement at reduced speed enables him to manage authorized movements of the work platform in a sufficiently safe way.

The prohibition on executing the movement of the work platform throughout the whole time of application of the first restricted operating mode is preferably always applied to the ascent movement of the work platform, as this is almost always dangerous when there is a crushing risk situation for the operator. In other words, in this case, the control panel is designed to allow the operator to engage an ascent movement of the work platform, and the method comprises prohibiting the ascent movement of the work platform throughout the whole time of application of the first restricted operating mode, regardless of the movement of the work platform that was in progress when the first rule was triggered.

According to an embodiment in which the aerial lift is self-propelled so as to be able to translate on the ground and the control panel is designed to enable the operator to selectively engage a translation on the ground of the aerial lift in forward motion, a translation on the ground of the aerial lift in backward motion, an ascent movement of the work platform and a descent movement of the work platform, the method comprises, during application of the first restricted operating mode due to triggering of the first rule at a time when the work platform was subjected to an ascent movement only, authorizing to execute only at a reduced speed with respect to a normal speed of movement any one of the translation on the ground of the aerial lift in forward motion, the translation on the ground of the aerial lift in the backward motion and the descent movement of the work platform. In this case, these three movements may be useful to the operator to enable him to free himself from a risk situation of crushing for him.

According to another embodiment in which the aerial lift is self-propelled so as to be able to translate on the ground and the control panel is designed to enable the operator to selectively engage a translation on the ground of the aerial lift in forward motion, a translation on the ground of the aerial lift in backward motion, an ascent movement of the work platform and a descent movement of the work platform, the method comprises, during application of the first restricted operating mode due to triggering of the first rule at a time when the work platform was subjected only to a translation on the ground of the aerial lift in backward motion, authorizing to execute only at a reduced speed with respect to a normal speed of movement the translation on the ground of the aerial lift in forward motion and the descent movement of the work platform. In this case, these two movements may be useful to the operator to enable him to free himself from a risk situation of crushing for him.

According to a preferred embodiment in which the control panel is designed to enable the operator to selectively engage any one of a plurality of different movements of the work platform, and in which at least one reset procedure is provided which can be executed at the control panel, the method comprises: in the event of the second rule being triggered, applying a second restricted mode of operation until the reset procedure is executed; and throughout the whole time of application of the second restricted mode of operation, authorizing any movement of the work platform to be executed only at a reduced speed with respect to a normal speed of movement. This enables the operator to move the work platform freely, despite the risk situation for the operator which led to the application of the second restricted operating mode. This promotes productivity and is acceptable in terms of safety for the operator since, as explained above, the movement of the work platform engaged by the operator is not the cause of the risk situation, and the reduced speed of movement of the work platform enables him to adequately manage a possible crushing risk himself.

Throughout the whole period of application of the second operating mode, it is advantageous to exclude the application of the first rule and to allow any movement of the work platform to be executed at the reduced speed, regardless of the detection system. Since the first rule is not applied during the second restricted operating mode and the detection system is not taken into account, any unintentional stoppages in movement of the work platform that might otherwise occur as a result of applying the first rule are avoided. This promotes productivity and avoids irritating the operator when the second restricted operating mode is applied.

According to a further preferred embodiment, the method comprises: when the first restricted operating mode is being applied, deactivating the first restricted operating mode in the event of execution of the reset procedure on condition that the detection system has ceased to detect the risk situation for the operator; and/or when the second restricted operating mode is being applied, deactivating the second restricted operating mode in the event of execution of the reset procedure on condition that the detection system has ceased to detect the risk situation for the operator. Deactivation of the first restricted operating mode, respectively the second restricted operating mode, causes a return to normal operating mode. The fact that the restricted operating modes are only terminated once the detection system has ceased to detect the risk situation for the operator advantageously ensures that the return to normal operating mode takes place under safe conditions for the operator.

According to another preferred embodiment, the reset procedure comprises or consists in disengaging any movement of the work platform at the control desk, the method comprising deactivating the first restricted operating mode and/or the second operating mode in the event of execution of the reset procedure on condition that any movement of the work platform is disengaged at the control desk and the detection system has ceased to detect the risk situation for the operator. In other words, the reset procedure only allows deactivation of the first restricted operating mode and/or the second operating mode if, at the same time, all movement of the work platform has been disengaged at the control desk and the detection system has ceased to detect the risk situation for the operator.

According to another preferred embodiment in which the aerial lift comprises a turret pivotally mounted on a frame, the turret supporting a lifting device for work platform, the control desk being designed to enable the operator to engage a rotation of the turret rotation, the method comprises: implementing the first rule according to which the rotation of the turret is stopped if the rotation of the turret is in progress at the time when the detection system detects the occurrence of the risk situation for the operator; and implementing the second rule according to which the rotation of the turret is executed at a reduced speed with respect to a normal speed of rotation of the turret if the risk situation for the operator is detected by the detection system at the time when the rotation of the turret is engaged at the control desk.

According to another aspect, the invention proposes a protection system for an operator of an aerial lift comprising a work platform and a control console provided for use on board the work platform and designed to enable the operator to engage at least one movement of the work platform, the protection system comprising: a detection system for detecting a risk situation for the operator on board the work platform; and a management system for the movement of the work platform, which management system is operatively connected to the detection system, the management system being configured to implement the method for protecting an operator against crushing according to the invention. In practice, the work platform can be moved at least in height.

According to a preferred embodiment of this protection system, the detection system is designed to detect a risk situation for the operator on board the work platform due to the movement of the work platform. More preferably, the detection system is suitable for detecting a crushing risk situation for the operator on board the work platform. Detection is preferably carried out with respect to the body of the operator. The above description of the detection system in the context of the method for protecting an operator on board a work platform of an aerial lift against crushing according to the invention is applicable in the context of the protection system according to this embodiment.

The management system can be implemented by on-board electronics of the aerial lift which is designed to control the movements of the work platform and more generally the movements of the aerial lift. The management system can also be a dedicated electronic circuit designed to interface with on-board electronics of the aerial lift which control the movements of the work platform and of the aerial lift. This electronic circuit can be housed, for example, in the control panel or in a box dedicated to the protection system, i.e. housing its detection system and its management system.

According to yet another aspect, the invention proposes an aerial lift, comprising a work platform displaceable at least in height and a control panel provided for use on board the work platform and designed to enable an operator to engage at least an ascent movement of the work platform and a descent movement of the work platform, the aerial lift further comprising a protection system for an operator of an aerial lift according to the invention.

According to a preferred embodiment, the aerial lift is self-propelled for translation on the ground in forward motion and in backward motion, the control panel being further designed to enable the operator to engage a translation on the ground of the aerial lift in forward motion and in backward motion.

In another preferred embodiment, the aerial lift is a scissor lift or an aerial lift with a fixed vertical mast. An aerial lift with a vertical mast is an aerial lift with a vertical mast that has no pivoting turret and whose mast orientation is fixed with respect to the aerial lift chassis on which it is mounted.

In yet another embodiment, the aerial lift comprises a turret mounted pivotally on a chassis, the turret supporting a lifting device for the work platform, the control panel being further designed to enable the operator to engage a rotation of the turret. In this case, the aerial lift is preferably an aerial lift with a telescopic mast or an aerial lift with an articulated mast or an aerial lift with a vertical mast and a swiveling turret.

### BRIEF DESCRIPTION OF THE FIGURES

Further aspects, features and advantages of the invention will become apparent from the following description of preferred embodiments of the invention, given by way of example and with reference to the appended drawing.

FIG. 1 shows a scissor lift according to a first preferred embodiment, with its work platform in the lowered position on its chassis.

FIG. 2 shows the same aerial lift, but with its work platform in the raised position.

FIG. 3 shows an isolated view of the control panel of the aerial lift, which is equipped with a detection system comprising two non-physical barriers.

FIG. 4 shows a local view of this aerial lift showing an end of the work platform and the control panel attached to the guardrail.

FIG. 5 shows a local schematic perspective view of the work platform of this aerial work platform, with an operator standing at the control console.

FIG. 6 shows a schematic top view for the case of the previous figure.

FIG. 7 shows a block diagram of the set formed by the control panel, the protection system for the operator and the on-board electronics of the aerial lift according to the first embodiment.

FIG. 8 shows an isolated view of another aerial lift control panel, which is equipped with a detection system comprising three non-physical barriers.

FIG. 9 is a local view of this aerial lift, showing one end of its work platform and the control panel from the previous figure attached to its guardrail.

FIG. 10 is a view similar to FIG. 4 and relates to an embodiment identical to the first embodiment described with reference to FIGS. 1 to 7, except for the detection system of the protection system for the operator.

FIG. 11 shows, for this embodiment, a local perspective view of the work platform of this aerial lift with an operator standing upright at the control console.

FIG. 12 schematically represents a top view for this embodiment, showing the measurement beam of a LIDAR or LADAR detector fitted to the detection system of the protection system for the operator and the normal positioning of the operator standing at the control console.

FIG. 13 shows an aerial lift according to another embodiment, the aerial lift being of an articulated type.

### DETAILED DESCRIPTION OF THE INVENTION

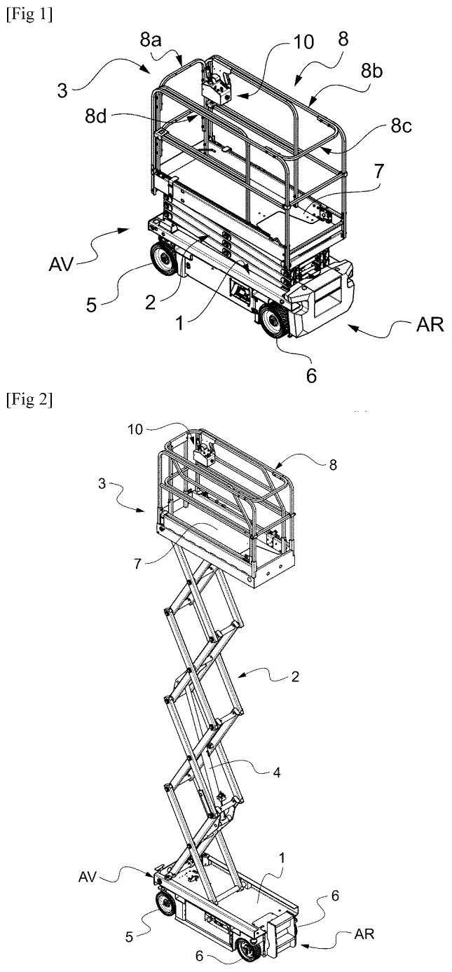

We will now describe the aerial lift according to the first preferred embodiment with reference to FIGS. 1 to 7. As can be seen from FIGS. 1 and 2, the aerial lift is a scissor lift. It comprises a chassis 1, a scissor lift mechanism 2 mounted on the chassis 1 and a work platform 3 mounted on the scissor lift mechanism 2. Work platform 3 has a horizontal platform 7 surrounded by a guardrail 8 to prevent people from falling off. Guardrail 8 comprises four sections 8a, 8b, 8c, 8d, each corresponding to a different side of platform 7. Platform 7 and guardrail 8 can include sliding parts at one or both ends of work platform 3 to enable users to vary the available work surface on board work platform 3.

Scissor lift mechanism 2 comprises beams hinged at their centers in a scissor-like fashion, these scissor mechanisms being mounted one above the other by their ends which are pivotally connected so that they can be deployed. A hydraulic cylinder 4—or alternatively several—allows to actuate the scissor lift mechanism 2 to lower and raise work platform 3 to the desired working height.

Chassis 1 is fitted with front wheels 5 and rear wheels 6, by means of which chassis 1 rests on the ground and enables the aerial lift to be translated on the ground. The front side of the aerial lift is referenced AV and its rear side is referenced AR. The aerial lift is motorized for autonomous movement on the ground. The motorization is generally mounted directly on chassis 1.

Alternatively, the invention also covers aerial lifts with vertical masts. In the case of vertical-mast aerial lifts, the lifting mechanism is designed in the form of an extendable mast comprising vertical parts that slide over one another to extend vertically to the desired working height. Sometimes, their lifting mechanism comprises a turret on which the extendable mast is mounted, the turret being pivotally mounted on the chassis about a vertical axis so as to vary the orientation of the work platform with respect to the chassis. Sometimes, the work platform is mounted on the higher vertical part by means of a pendulum arm—i.e. an arm articulated to the vertical mast around a horizontal axis—to give the user greater flexibility in reaching the working position.

More generally, the invention relates to any other type of aerial lift, whatever the type of lifting mechanism of the platform, in particular telescopic or articulated aerial lifts. The invention is also applicable to aerial lifts that are not motorized for autonomous ground travel but are towed or pushed for this purpose.

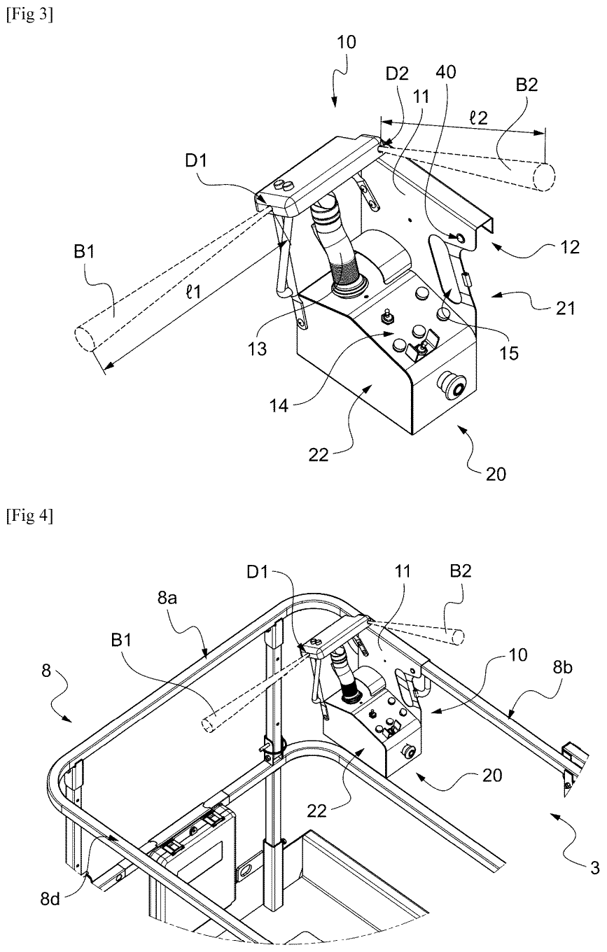

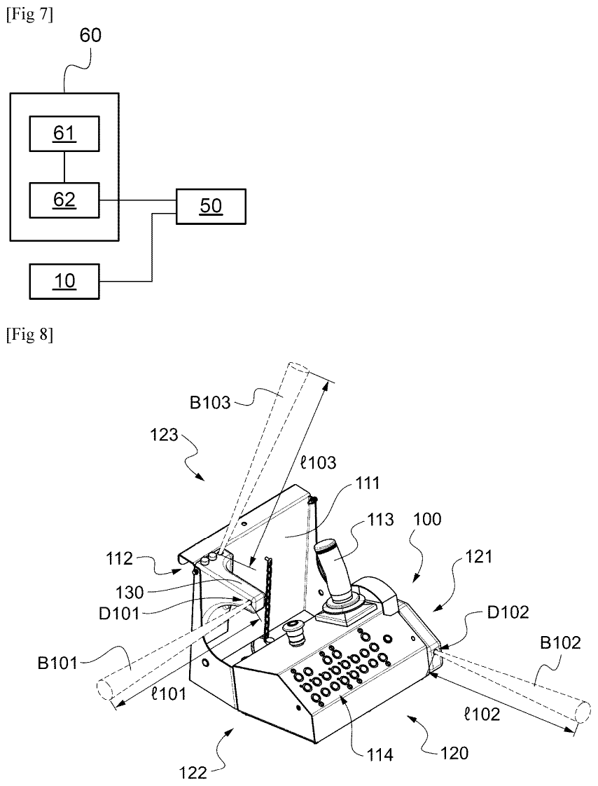

Work platform 3 is equipped with a control panel 10 shown in FIGS. 3 and 4. Control panel 10 is equipped with control members enabling an operator to cause the work platform 3 to move to the desired working position. In this example, buttons 14 are used to select the type of movement that can be engaged with a control handle 13 from translation of the aerial lift on the ground and vertical displacement of work platform 3. Control handle 13 is used to execute the selected type of movement: it can be tilted forwards and backwards in order, according to the case, to raise or lower work platform 3, or to move the aerial lift forwards or backwards. In other words, the operator engages the desired movement by tilting control handle 13. In normal operation, the engaged movement is executed as long as control handle 13 is kept tilted, and is stopped when the operator lets control handle 13 return to its neutral position. Control handle 13 allows to vary the speed of the selected movement according to its degree of inclination, preferably proportionally. Buttons—not shown—on the top of control handle 13 can be used to change the orientation of the steered wheels, in this case the front wheels 5—alternatively, the rear wheels 6. Control panel 10 has a wired connection—not shown—or, alternatively, a wireless connection to on-board electronics 50—see FIG. 7—housed, for example, under the chassis 1. The on-board electronics 50 controls the power members of the aerial lift, in particular the motorization and hydraulic cylinder(s) 4, depending in particular on the commands engaged by the operator at control panel 10.

Control panel 10 is removable and designed to be hung at various points on guardrail 8 for convenient maneuvering of the aerial lift by the operator on board work platform 3. To this end, control panel 10 has on its right side 21 a side plate 11 extending vertically with respect to the housing of the control panel 10. At its upper end, plate 11 has a suitable shape 12—for example, an upside-down U-section—enabling control desk 10 to be hooked onto a correspondingly dimensioned horizontal bar of guardrail 8. The hooking system can be different and can be made in any suitable way that allows the operator to manually unhook or hook control desk 10 to guardrail 8 without the need for tools. There may also be a system for manually locking control panel 10 to guardrail 8, or a system for indexing control panel 10 on guardrail 8 by means of, for example, a pin in order to prevent control panel 10 from sliding on the guardrail 8, for example under the effect of vibrations.

Control panel 10 is also designed to be held with one hand, so that the operator can manipulate control members 13, 14 with the other. This enables the operator to control the aerial lift from the ground. For this purpose, control panel 10 is fitted with a handle 15, in this example in the form of an opening in side plate 11. In addition, control panel 10 is sufficiently compact—preferably less than 30 cm wide, or even less than 25 cm—and of suitably low weight.

When on board work platform 3, the operator manipulates control members 13, 14 of control panel 10 when hooked to guardrail 8. The operator hangs control panel 10 towards the front end of the long section 8b of guardrail 8, as shown in FIGS. 1, 2 and 4.

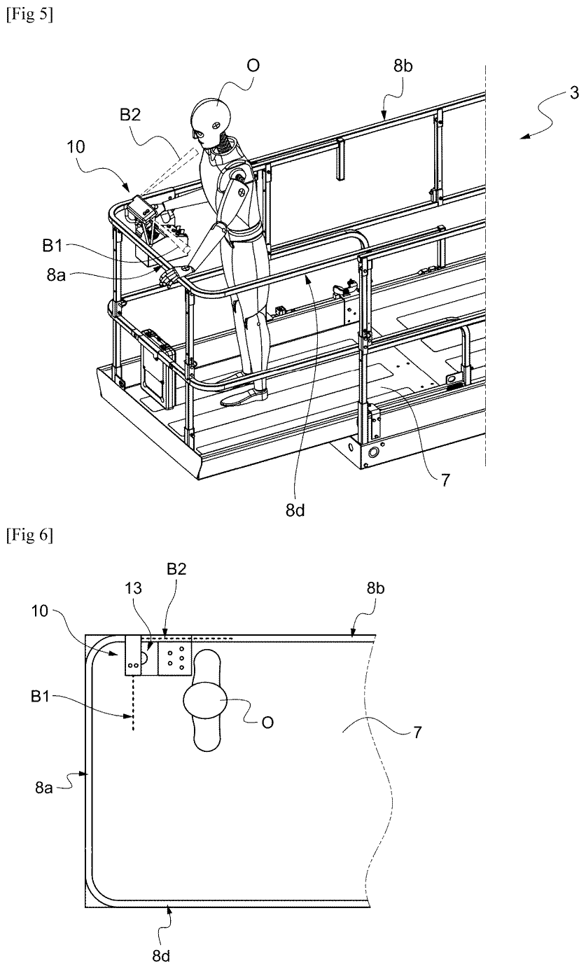

Given the narrow width of control panel 10 and the fact that its attachment to guardrail 8 is arranged on the right side 21, the operator usually stands on the left side 22 of control panel 10 when manipulating control members 13, 14, in this case with his right hand. This position is illustrated in FIG. 5, where the operator is referred to by the letter O. The operator is also represented symbolically in FIG. 6. The risk of the operator being crushed is therefore primarily due to an obstacle outside the aerial lift striking him from behind when the aerial lift moves backwards, or from above when work platform 3 is raised.

Nevertheless, the operator is also likely to approach section 8b of guardrail 8 and lean over it, for example to look at the orientation of the wheels of the aerial lift. The operator is even likely to position himself in front of the front side 20 of control panel 10 by facing section 8b of guardrail 8, while manipulating control members 13, 14 with his left hand and leaning over section 8b of guardrail 8. The risk of being crushed against guardrail 8b comes primarily from an external obstacle above him if he engages an ascent movement of work platform 3.

To ensure the safety of the operator, control panel 10 is fitted with a system to protect the operator from being crushed while on board work platform 3: this protection system is referenced 60 in FIG. 7. Protection system 60 is designed to protect the operator against the risk of being crushed by an external obstacle—such as a part of a building or structure, or a tree branch—striking him from behind or above. It includes a detection system 61 comprising two non-physical barriers shown in FIGS. 3 to 6.

A first non-physical barrier B1 is erected in front of the part of section 8a of guardrail 8 adjacent to the left side 22 of control panel 10. A second non-physical barrier B2 is erected above the part of section 8b of guardrail 8 adjacent to the right side of control console 10 and extends beyond front side 20 of control console 10 in the direction towards the rear of work platform 3. For further details on the implementation of the non-physical barriers B1 and B2, one may refer to WO 2017/178737.

In this embodiment, a situation potentially presenting a crushing risk for the operator is considered to exist as soon as interference with any of the two non-physical barriers B1, B2 is detected. In the rest of the description of this embodiment, mentioning that detection system 61 detects a risk situation for the operator means that detection system 61 detects interference with any one of the two non-physical barriers B1, B2. Conversely, stating that detection system 61 does not detect a risk situation for the operator means that detection system 61 does not detect any interference with any of the two non-physical barriers B1, B2.

As shown in FIG. 7, protection system 60 also includes a management system 62 for the movement of work platform 3. Detection system 61 is functionally connected to management system 62, which is designed to manage the movement of work platform 3 as a function of a detection signal supplied to it by detection system 61. To this end, management system 62 may consist of its own electronic circuit interfaced with on-board electronics 50 of the aerial lift. Alternatively, management system 62 can be fully implemented by on-board electronics 50 of the aerial lift.

We will now describe how protection system 60 manages the movements of work platform 3 through management system 62 in cooperation with detection system 61.

Management system 62 authorizes normal operation in the absence of detection of a risk situation for the operator by detection system 61, i.e. in the absence of interference with one of the non-physical barriers B1, B2. In this case, management system 62 authorizes unrestricted execution of the movements of work platform 3. In other words, when the operator engages any movement of work platform 3, including via translation on the ground, at control desk 10, management system 62 authorizes its execution without restriction, and on-board electronics 50 thus implements it at a normal speed of movement.

In the normal operating mode, protection system 60 is preferably designed not to influence the translation on the ground of the aerial lift when work platform 3 is in a fully lowered position, as the operator is then in the situation of an ordinary motor vehicle driver. In other words, translation on the ground of the aerial lift is authorized regardless of detection system 61 as soon as work platform 3 is in a fully lowered position, in accordance with the third rule stated above. In still other words, the first and second rules are only implemented if work platform 3 is at least partially raised.

Furthermore, in the normal operating mode, protection system 60 is preferably designed not to influence the execution of a movement of work platform 3 when the movement concerned is considered to be inherently risk-free for the operator. In this way, protection system 60 can be designed to always authorize the descent movement of work platform 3, regardless of detection system 61. In other words, the descent movement of the platform is executed at its normal speed as long as this movement is engaged at control panel 10, regardless of whether or not there is interference with any of the non-physical barriers B1, B2. Indeed, there is no risk of the operator being crushed during the descent movement of work platform 3.

Similarly, management system 62 can be designed to always authorize translation on the ground of the aerial lift in forward motion, regardless of detection system 61. In other words, translation on the ground of the aerial lift in forward motion is executed at its normal speed as long as it is engaged at control panel 10, regardless of whether or not there is interference with any of the non-physical barriers B1, B2. In this case too, the risk of crushing for the operator remains low. This is all the more the case if the control console is fixedly mounted on work platform 3 towards the front of the latter, contrary to the case of the embodiment described, since in this case the operator at the control console normally looks towards the front of the aerial lift.

Furthermore, it is advantageous for management system 62 to authorize the wheels to change orientation independently of any detection of a risk situation for the operator by detection system 61. This is because changing the orientation of the wheels does not involve any movement of work platform 3 and therefore poses no risk to the operator. And this allows the operator to lean over guardrail 8 to see the orientation of steered wheels 5 or 6 during the wheel orientation change that he operates at control console 10.

In the normal operating mode, however, protection system 60 is designed to influence the execution of a movement of work platform 3 if a risk situation for the operator is detected, when the movement concerned is considered to be a risk for the operator. This is generally the case for the ascent movement of work platform 3. In the present embodiment, it is also the case for the translation on the ground of the aerial lift in backward motion. These movements will be referred to as risky movements in the following.

Alternatively, however, it is possible to treat the translation movement on the ground of the aerial lift in forward motion and/or the descent movement of work platform 3 as risky movements in the same way as the translation movement on the ground of the aerial lift in backward motion and the ascent movement of work platform 3, and thus to influence their execution in a similar way if a risk situation is detected for the operator.

The way in which management system 62 influences the execution of a risky movement of work platform 3 engaged at control console 10 in the event of the detection of a risk situation for the operator differs according to the chronology between the moment when the movement of work platform 3 is engaged at the control console 10 and the moment when detection system 61 detects the risk situation for the operator.

If the risky movement of work platform 3 is in progress when detection system 61 detects the occurrence of a risk situation for the operator, management system 62 stops this movement in application of the first rule. This is the situation where the risky movement of work platform 3 is engaged by the operator at control desk 10 at a time when detection system 61 does not detect a risk situation for the operator but subsequently detects one while the risky movement of work platform 3 is in progress: the first rule is then triggered. Management system 62 immediately stops the risky movement of work platform 3 as soon as detection system 61 signals to it the existence of the risk situation for the operator.

In other words, in this embodiment, if during normal operation, the operator engages the ascent movement of work platform 3 or the translation on the ground of the aerial lift in backward motion at control console 10 at a time when there is no interference with either of non-physical barriers B1, B2, but such interference occurs while one or the other of these movements is in execution, management system 62 causes immediately this movement to be stopped. On the other hand, as explained above, it is advantageous that the first rule does not apply to the descent movement of work platform 3, nor to the translation on the ground of the aerial lift in forward motion.

When the first rule is triggered, management system 62 also immediately applies a first restricted operating mode in replacement to the normal operating mode. This first restricted operating mode is applied at least until a reset procedure is executed.

The risky movement which has been stopped by management system 62 in application of the first rule remains prohibited for the entire time the first restricted operating mode is applied, even if detection system 61 ceases to detect the risk situation. This prevents the risky movement from automatically restarting if the risk situation for the operator is removed.

During the first restricted operating mode, management system 62 also applies restrictions to the execution of the movements of work platform 3 other than the one stopped by application of the first rule, if they are engaged at control desk 3 after activation of the first restricted operating mode. The nature of the restriction again differs according to whether the concerned movement of work platform 3 is considered to be at risk or not for the operator. More precisely, depending on the concerned movement of work platform 3, management system 62 either prohibits its execution, or authorizes it but only at a reduced speed with respect to a normal speed of the movement.

During the first restricted operating mode, any movement of work platform 3 considered to be at risk is preferably prohibited. In particular, it is preferable that execution of the ascent movement of work platform 3 always be prohibited, regardless of the movement in progress of work platform 3 which has been stopped in application of the first rule.

On the other hand, any movement of work platform 3 considered to have the potential to reduce or eliminate the risk of crushing for the operator when a movement in progress of work platform 3 has been stopped in application of the first rule is preferentially authorized at reduced speed during the first restricted operating mode. In this sense, if the movement in progress of work platform 3 that has been stopped in application of the first rule is the ascent movement, then management system 62 preferentially authorizes execution at reduced speed of the translation on the ground of the aerial lift in forward motion, the translation on the ground of the aerial lift in reverse motion and the descent movement of work platform 3. If the movement in progress of work platform 3 which has been stopped in application of the first rule is the translation on the ground of the aerial lift in backward motion, then management system 62 preferably authorizes the execution at reduced speed of the translation on the ground of the aerial lift in forward motion and the descent movement of work platform 3. By contrast, management system 62 prohibits the ascent movement of work platform 3 as previously mentioned.

If, during the normal operation mode, detection system 61 detects a risk situation for the operator when he engages a risky movement of work platform 3 at control console 10, the second rule is triggered. In other words, management system 62 authorizes execution of this risky movement of work platform 3, but only at a reduced speed with respect to the normal speed of the movement. This is a case where the risk situation for the operator detected by detection system 61 pre-exists or occurs simultaneously with the engagement of this movement of work platform 3 at control console 10 by the operator.

In other words, in this embodiment, if, during the normal operation mode, the operator engages at control desk 10 the ascent movement of work platform 3 or the translation on the ground of the aerial lift in backward motion at a time when there is an interference with either of non-physical barriers B1, B2, management system 62 authorizes execution of this movement, but only at the reduced speed. By contrast, as explained above, it is preferable that the second rule does not apply to the descent movement of work platform 3, nor to the translation on the ground of the aerial lift in forward motion.

The risky movement of work platform 3 engaged at control panel 10 under the conditions of the second rule is preferably executed at reduced speed for as long as it remains engaged at control panel 10, even if the detection system ceases to detect the risk situation for the operator. This avoids any variations in movement speed which could destabilize the operator.

It is even more preferable to exclude the application of the first rule when a movement is in progress at reduced speed and to have the movement of work platform 3 executed at the reduced speed in application of the second rule as long as it remains engaged at the control desk without taking the detection system into account. In this way, productivity is improved by avoiding movement stoppages of work platform 3 that would otherwise be caused by the application of the first rule. The safety of the operator is nevertheless sufficiently ensured by the reduced speed of movement, enabling him to react in the event of danger.

Even more advantageously, it can be provided that as soon as the second rule is triggered, management system 62 immediately applies a second restricted operating mode in replacement to the normal operating mode. This second restricted operating mode is applied until a reset procedure is executed. Preferably, management system 62 authorizes any movement of work platform 3 that the operator engages at control desk 10 to be executed during the second restricted operating mode, but only at a reduced speed with respect to a normal speed of movement. In other words, no movement of work platform 3 is executed at the normal operating speed during the second restricted operating mode. It is even more advantageous that management system 62 does not apply the first rule during the second restricted operating mode and allows any movement of work platform 3 to be executed at the reduced speed regardless of detection system 61. In this way, protection system 60 will not cause stoppages of the work platform 3 during the second restricted operating mode. These measures are all aimed at increasing productivity, while ensuring operator safety satisfactorily due to the reduced speed of the movements of work platform 3 during the second restricted operating mode.

In this embodiment, the operation of control handle 13 during the application of the first restricted operating mode and during the application of the second restricted operating mode is preferably similar to the normal operating mode. In other words, any movement of work platform 3 authorized only at a reduced speed in the first restricted operating mode or in the second restricted operating mode, which is engaged at control handle 13 is executed as long as control handle 13 is kept inclined and is stopped when the operator let control handle 13 return to its neutral position. And the speed of the selected movement also varies with the degree of inclination of control handle 13, preferably proportionally. Simply, the maximum value of the speed of the movement concerned is reduced during the application of one or the other of the restricted operating modes with respect to the maximum value of the speed of this movement during the normal operating mode. This prevents the operator from being disturbed by different functioning of control handle 13 when the restricted operating modes are applied.

Whether during the first restricted operating mode or during the second restricted operating mode, it is preferable that the maximum value of the reduced speed of a movement of work platform 3 be less than or equal to half the maximum value of the normal speed of this same movement, and is even more preferably less than or equal to a quarter or even a fifth of the latter.

As mentioned, the first restricted operating mode and the second restricted operating mode can be deactivated to return to the normal operating mode by means of a reset procedure. At least one reset procedure is provided which can be executed at control panel 10 by the operator, thus avoiding the need for intervention by a third party. This reset procedure is preferably the same for both restricted operating modes. It is preferable to deactivate each of the restricted operating modes by executing the reset procedure only when detection system 61 has ceased to detect a risk situation for the operator, thus enabling a particularly safe transition to the normal operating mode for the operator.

By way of example, the reset procedure consists in disengaging any movement of work platform 3 at control console 10. In other words, in this embodiment, the operator must let control handle 13 return to the neutral position. In addition, operator O must reposition himself so that he no longer interferes with non-physical barriers B1 and B2, in order to deactivate the current restricted operating mode and reactivate the normal operating mode. In other words, when these two conditions are satisfied simultaneously, operator O can restart the relevant movement by re-engaging it at control panel 10 or engage another movement of work platform 3 at control panel 10, the movement then being executed at its normal speed in accordance with normal operating mode. The simplicity of this reset procedure has the advantage of promoting productivity while favoring a safe transition to the normal operating mode since no movement is engaged at control panel 10 at the time of transition to the normal operating mode.

Alternatively, the reset procedure may also include pressing a reset button on control panel 10.

Optionally, a push-button 40—or another type of manually operated member—can be arranged on control member 10 to enable the operator to override protection system 60, i.e. to prevent protection system 60 from stopping the movements of work platform 3, including through translation on the ground of the aerial lift, or from reducing their speed. This prevents accidental triggering of protection system 60 when control panel 10 is not attached to guardrail 8, but the operator is holding control panel 10 by hand. It is preferable for the override to be effective only as long as the operator keeps push-button 40 or the member in question actuated. It is also preferable for the operator to be informed that protection system 60 has been overridden by a signalization on control panel 10 or otherwise. It is preferable to provide such a member for overriding protection system 60 only for control panels of the removable type which are designed to be used with one hand by the operator while he holds it with his other hand.

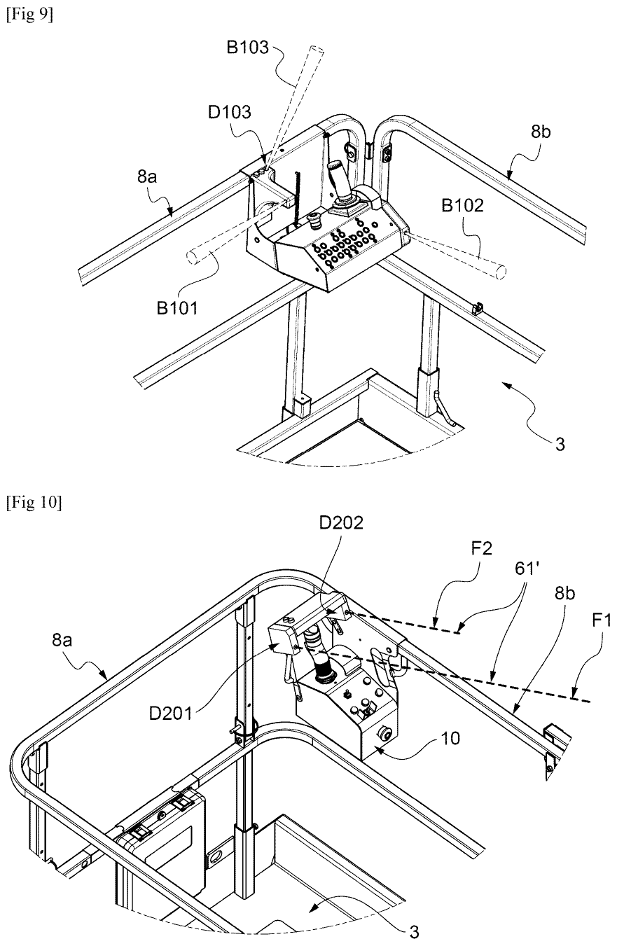

FIGS. 8 and 9 illustrate a second preferred embodiment using another control panel—referenced 100—provided with manual control members 113, 114 similar to those of control panel 10. The elements corresponding to those of control panel 10 are referenced by the same numbers increased by 100.

The entire description given for the first preferred embodiment is applicable to this second preferred embodiment, except for the differences discussed below.

Control panel 100 is also removable and designed to be hooked at various points on guardrail 8 by the operator without the use of tools. In this case, however, its attachment system 112 is located on the rear side 123 of control panel 100. Control panel 100 is wider and heavier than control panel 10 and is not designed to be held with one hand while manipulating control members 113, 114 with the other hand.

Control panel 100 includes a protection system for the operator comprising a detection system with two non-physical barriers B101, B102 which respectively perform the same function as non-physical barriers B1, B2 of control panel 10. Note that the photoelectric sensor D102 of non-physical barrier B102 is housed laterally in the lower part of the front side of control panel 100. The photoelectric sensor D101 of non-physical barrier B101 is housed in a support 130 which advances with respect to a rear plate 111 for mounting on guardrail 8. This allows non-physical barrier B101 to be positioned at the appropriate distance from section 8a of the guardrail 8.

Finally, since control panel 100 is wider than control panel 10, it is desirable to protect the operator from the risk of being crushed against control panel 100. To this end, the detection system includes a third non-physical barrier B103. The non-physical barrier B103 extends above control desk 100, preferably from its rear 123, so that the operator does not interfere with the non-physical barrier B103 when standing upright at control desk 100, but does interfere with it when leaning over control desk 100 beyond a certain angle. To this end, it is advantageous for non-physical barrier B103 to extend from the rear 123 of control desk 100, pointing upwards towards the front 120 of control desk 100, as shown. For further details on the implementation of non-physical barriers B101, B102 and B103, one may refer to WO 2017/178737.

In this second embodiment, a protection system similar to protection system 60 of the first embodiment is provided: its management system implements the same management of the movements of the work platform as management system 62 of the first embodiment. The only difference is that a crushing risk situation for operator O is determined this time by the detection of an interference with any of non-physical barriers B101, B102 and B103.

Preferably, the maximum detection distance of non-physical barriers B101, B102 and B103, like that of non-physical barriers B1, B2 of the first embodiment, should be suitably limited, to avoid unintentional triggering of the protection system when the working environment at height is cluttered. From this point of view, it is preferable for the maximum detection distance of each of the non-physical barriers, measured from control panel 10, 100, to be less than or equal to 100 cm, and more preferably less than or equal to 60 cm. This maximum detection distance is referenced 11 and 12 respectively for non-physical barriers B1 and B2 of control panel 10—see FIG. 3—and it is referenced 1101, 1102 and 1103 respectively for non-physical barriers B101, B102 and B103 of control panel 100.

FIGS. 10 to 12 illustrate a third preferred embodiment which is based on the first embodiment described with reference to FIGS. 1 to 7. The only differences in this third embodiment with respect to the first embodiment lie in the detection system of the operator protection system 60. Consequently, all the description given for the first embodiment applies to this third embodiment, and the same reference numbers are used to designate the same elements, except for the detection system—hereinafter referred to as 61′—and its components. As in the first embodiment, detection system 61′ is functionally linked to management system 62. Detection system 61′ is based on one or more LIDAR or LADAR sensors. It will now be described in greater detail.

Detection system 61′ comprises a first LIDAR or LADAR sensor referenced D201. Sensor D201 is arranged on control panel 10 so as to point forward from control panel 10 towards where operator O normally stands in front of control panel 10 when using it to control the movements of work platform 3. The measurement beam of sensor D201 is symbolized by dashes and is referenced F1. Sensor D201 is therefore used to measure the distance between operator O and control panel 10 when standing in front of control panel 10.

As shown in FIG. 12, sensor D201 is used to define a protected driving area referenced Z2 in which operator O is expected to stand when using control panel 10. Protected driving area Z2 corresponds to a defined distance interval with respect to sensor D201. Protected driving area Z2 is defined as extending from a distance L1 to a distance L2 greater than L1, both defined with respect to sensor D201. This distance interval is defined so as to correspond to a position of operator O with respect to control panel 10 that is neither too close nor too far away from it.

During operation, operator O is considered to be potentially in a risk situation whenever the distance of operator O measured by sensor D201 is outside this distance range. This is the case if operator O is standing in an area Z1 corresponding to a distance less than distance L1 with respect to sensor D201. This is also the case if operator O is standing in an area Z3 corresponding to a distance greater than distance L2 with respect to sensor D201.

It is considered that there is also potentially a risk situation for operator O in the event that sensor D201 fails to report a distance measurement, because operator O is standing outside measurement beam F1 or beyond the measurement range of sensor D201 which in this case is a distance L3 greater than L2.

In short, during operation, a risk situation is considered to exist potentially if detection system 61′ determines by means of sensor D201 that operator O is outside the Z2 zone.

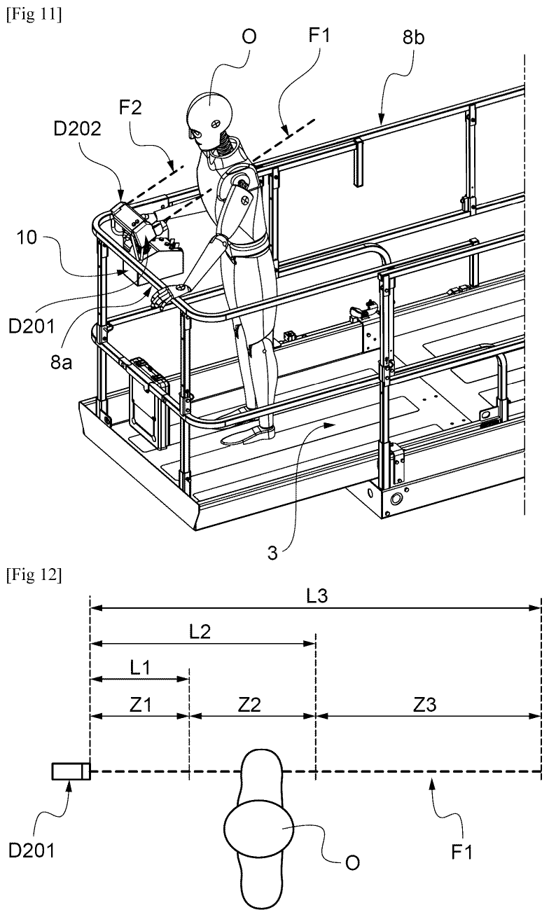

Detection system 61′ can be supplemented by a second LIDAR or LADAR sensor, referenced D202. Its measurement beam is referenced as F2 in FIGS. 10 and 11. Sensor D202 is dedicated to detecting a risk for operator O being crushed against section 8b of guardrail 8 next to control panel 10, when it is hooked onto the dedicated part of guardrail 8. Second sensor D202 is useful due to the small size of control desk 10. Indeed, it is possible that detection system 61′ determines that operator O is within the distance interval with respect to first sensor D201 which corresponds to zone Z2, while he may simultaneously be leaning towards section 8b, which potentially corresponds to a crushing risk situation for operator O.

Sensor D202 is arranged on control panel 10 in such a way that, on the one hand, its measuring beam F2 does not encounter operator O when he is standing normally upright at control panel 10, i.e. without leaning towards section 8b of guardrail 8. And on the other hand, sensor D202 is arranged on control console 10 so that its measurement beam F2 encounters operator O when he is leaning towards section 8b while he is located in the distance interval with respect to first sensor D201 which corresponds to zone Z2. As can be seen in FIGS. 11 and 12, it is located on the lateral side of control panel 10 which is close to panel 8b. The measuring range of sensor D202 may be more limited than that of sensor D201.

Consequently, it is considered that there is potentially a risk situation for operator O when sensor D202 provides a distance measurement due to the fact that operator O cuts measurement beam F2.

Sensor D202 thus makes it possible to laterally delimit the protected driving zone Z2 on the side corresponding to section 8b of guardrail 8.

It will be understood that sensor D202 provides the same protective function as non-physical barrier B2 in the first embodiment. Alternatively, sensor D202 is replaced by non-physical barrier B2 of the first embodiment.

In summary, in this third embodiment, detection system 61′ detects a potential risk situation for operator O when it determines, by means of sensors D201 and D202, that operator O is outside protected driving zone Z2. In cooperation with detection system 61′, management system 62 of the operator protection system implements the same management of the movements of work platform 3 as described above for the first embodiment.

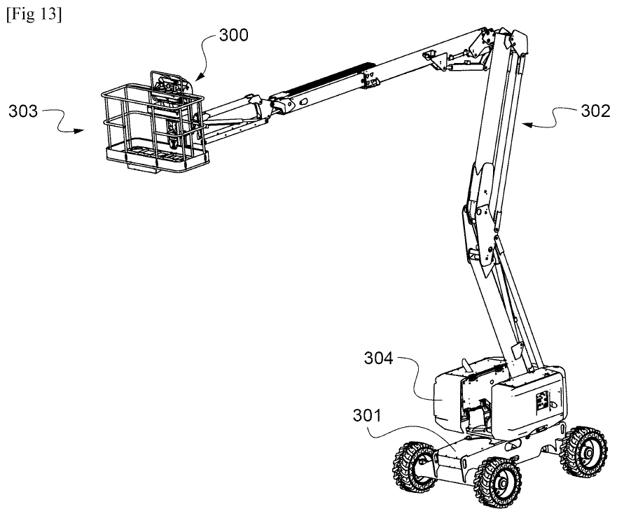

FIG. 13 shows a self-propelled aerial lift according to another embodiment which aerial lift is of the articulated type. It comprises a frame 301 supporting a lifting device 302 for a work platform 303. Lifting device 302 comprises, in a known manner, two articulated arms supporting at their upper end a telescopic arm at the end of which work platform 303 is supported, possibly by means of a small pendulum arm. Lifting device 302 is mounted on frame 301 by means of a turret 304. Turret 304 can rotate about a vertical axis with respect to frame 301, which makes it possible to change the angular orientation of lifting device 302 with respect to the frame.

A control panel 300 is fixedly mounted on or close to the guardrail of work platform 303. Control panel 300 enables an operator to engage various movements of work platform 303, including translation on the ground of chassis 301. It therefore allows the aerial lift to be translated on the ground in forward motion and in backward motion, work platform 303 to be raised or lowered and turret 304 to be rotated with respect to chassis 301.

Control panel 300 is equipped with a protection system for the operator on board the aerial lift, which operates in a similar way to those described so far. In other words, it includes a detection system to detect a risk situation for the operator on board work platform 303. The detection system may be similar to any of the previously described embodiments.

The detection system is operatively linked to a management system which manages the movements of work platform 303, in particular on the basis of the detection signal provided by the detection system.

The management system manages the movements of work platform 303 in the same way as described for the previously described embodiments but additionally manages the rotational movement of turret 304. From this point of view, the rotational movement of turret 304 is considered to be a risky movement in both directions of rotation. In other words, the first rule is also implemented with regard to the rotation of turret 304, i.e. to stop its rotation if it is in progress at the time when a risk situation for the operator is detected. In this case, the first restricted operating mode will authorize rotation of turret 304 at a reduced speed in the opposite direction with respect to the direction of rotation which has been stopped in application of the first rule. If the second rule is triggered, rotation of turret 304 will also be authorized, but only at a reduced speed with respect to the normal speed of rotation, regardless of the direction of rotation. The first restricted mode of operation and the second restricted mode of operation described for the other embodiments can be applied in the same way by considering that the rotational movement of turret 304 is a risky movement in both directions of rotation.

Of course, the present invention is not limited to the examples and embodiments described and shown, but is susceptible to numerous variants accessible to the skilled in the art.

1. A method for protecting an operator on board a work platform of an aerial lift against crushing, which method is implemented automatically, the aerial lift comprising a control panel arranged for use on board the work platform and designed to enable the operator to engage a movement of the work platform, the aerial lift further comprising a detection system arranged to detect a risk situation for the operator on board the work platform, the method comprising:
implementing a first rule according to which the movement of the work platform is stopped if the movement is in progress at the time when the detection system detects the occurrence of the risk situation for the operator, and
implementing a second rule according to which the movement of the work platform is executed at a reduced speed with respect to a normal speed of the movement if the risk situation for the operator is detected by the detection system at the time of engaging the movement at the control desk.

2. The method according to claim 1, which comprises:
after triggering of the second rule, executing the movement of the work platform at the reduced speed as long as the movement remains engaged at the control desk, even if the detection system ceases to detect the risk situation for the operator.

3. The method according to claim 1, wherein the method comprises:
excluding the application of the first rule when the movement is in progress at the reduced speed, and
after triggering of the second rule, executing the movement at the reduced speed as long as the movement remains engaged at the control panel, regardless of the detection system.

4. The method according to claim 1, wherein the control panel is designed to enable the operator to engage an ascent movement of the work platform, the method comprising:
implementing the first rule according to which the ascent movement of the work platform is stopped if the ascent movement of the work platform is in progress at the time when the detection system detects the occurrence of the risk situation for the operator, and
implementing the second rule according to which the ascent movement of the work platform is executed at a reduced speed with respect to a normal speed of the movement if the risk situation for the operator is detected by the detection system at the time of engaging the ascent movement of the work platform at the control desk.

5. The method according to claim 1, wherein the aerial lift is self-propelled so as to be able to translate on the ground, the control desk being designed to enable the operator to engage a translation on the ground of the aerial lift, the method comprising:
implementing the first rule according to which translation on the ground of the aerial lift is stopped if translation on the ground of the aerial lift is in progress at the time when the detection system detects the occurrence of the risk situation for the operator, and
implementing the second rule according to which the translation on the ground of the aerial lift is executed at a reduced speed with respect to a normal speed of translation on the ground of the aerial lift if the risk situation for the operator is detected by the detection system at the moment of engaging the translation on the ground of the aerial lift at the control desk.

6. The method according to claim 5, comprising:
implementing the first rule and the second rule only if the work platform is at least partially raised, and
implementing a third rule wherein translation on the ground of the aerial lift is permitted regardless of the detection system, on condition that the work platform is in a fully lowered position.

7. The method according to claim 1, wherein the control panel is designed to enable the operator to selectively engage any one of several different movements of the work platform, the method comprising:
excluding at least one movement of the work platform from the implementation of the first rule and of the second rule so as to authorize this movement of the work platform regardless of the detection system.

8. The method according to claim 7, wherein the control panel is designed to enable the operator to engage a descent movement of the work platform, the method comprising:
excluding the descent movement of the work platform from the implementation of the first rule and the second rule so as to authorize the descent movement of the work platform regardless of the detection system.

9. The method according to claim 7, wherein the control panel is designed to enable the operator to engage translation on the ground of the aerial lift in forward motion, the method comprising:
excluding translation on the ground of the aerial lift in forward motion from the implementation of the first rule and the second rule so as to authorize translation on the ground of the aerial lift in forward motion regardless of the detection system.

10. The method according to claim 1, wherein at least one reset procedure is provided, the reset procedure being executable at the control panel, the method comprising:
in the event of the first rule being triggered, applying a first restricted operating mode until the reset procedure is executed, and
prohibiting the movement throughout the whole time of application of the first restricted operating mode.

11. The method according to claim 10, wherein the control panel is designed to enable the operator to selectively engage any one of a plurality of different movements of the work platform, the method comprising for each of the movements of the work platform:
either prohibiting the movement of the work platform to be executed throughout the whole time of application of the first restricted operating mode,
or allowing the movement of the work platform to be executed only at a reduced speed with respect to a normal speed of the movement throughout the whole time of application of the first restricted operating mode.

12. The method according to claim 10, wherein the control panel is designed to enable the operator to selectively engage any one of a plurality of different movements of the work platform, the method comprising for each of the movements of the work platform:
either prohibiting the movement of the work platform to be executed throughout the whole time of application of the first restricted operating mode,
or allowing the movement of the work platform to be executed only at a reduced speed with respect to a normal movement speed, without regard to the detection system, throughout the whole time of application of the first restricted operating mode.

13. The method according to claim 11, wherein the control panel is designed to allow the operator to engage an ascent movement of the work platform, the method comprising:
prohibiting the ascent movement of the work platform throughout the whole time of application of the first restricted operating mode, irrespective of the movement of the work platform which was in progress when the first rule was triggered.

14. The method according to claim 11, wherein the aerial lift is self-propelled so as to be translatable on the ground and the control panel is designed to enable the operator to selectively engage a translation on the ground of the aerial lift in forward motion, a translation on the ground of the aerial lift in backward motion, an ascent movement of the work platform and a descent movement of the work platform, the method comprising during application of the first restricted operating mode due to triggering of the first rule at a time when the work platform was subjected to an ascent movement only:
authorizing to execute only at a reduced speed with respect to a normal speed of movement, any of the translation on the ground of the aerial lift in forward motion, the translation on the ground of the aerial lift in backward motion and the descent movement of the work platform.

15. The method according to claim 11, wherein the aerial lift is self-propelled so as to be able to translate on the ground and the control panel is designed to enable the operator selectively to engage a translation on the ground of the aerial lift in forward motion, a translation on the ground of the aerial lift in backward motion, an ascent movement of the work platform and a descent movement of the work platform, the method comprising during application of the first restricted mode of operation due to triggering of the first rule at a time when the work platform was subjected solely to a translation on the ground of the aerial lift in backward motion:
authorizing to execute only at a reduced speed with respect to a normal speed of movement the translation on the ground of the aerial lift in forward motion and the descent movement of the work platform.

16. The method according to claim 1, wherein the control panel is designed to allow the operator to selectively engage any one of a plurality of different movements of the work platform and at least one reset procedure is provided, the reset procedure being executable at the control panel, the method comprising:
in the event of the second rule being triggered, applying a second restricted operating mode until the reset procedure is executed, and
throughout the whole time of application of the second restricted operating mode, authorizing any movement of the work platform to be executed only at a reduced speed with respect to a normal speed of movement.

17. The method according to claim 16, further
comprising during the whole time the second operating mode is applied:
excluding the application of the first rule and allowing any movement of the work platform to be executed at the reduced speed regardless of the detection system.

18. The method according to claim 10, comprising:
when the first restricted operating mode is being applied, deactivating the first restricted operating mode in the event of execution of the reset procedure on condition that the detection system has ceased to detect the risk situation for the operator, and/or:
when the second restricted operating mode is being applied, deactivating the second restricted operating mode in the event of execution of the reset procedure on condition that the detection system has ceased to detect the risk situation for the operator.

19. The method according to claim 10, wherein the reset procedure comprises or consists in disengaging any movement of the work platform at the control desk, the method comprising deactivating the first restricted operating mode and/or the second restricted operating mode in the event of execution of the reset procedure on condition that any movement of the work platform is disengaged at the control desk and the detection system has ceased to detect the risk situation for the operator.

20. The method according to claim 1, wherein the aerial lift comprises a turret pivotally mounted on a frame, the turret supporting a lifting device for the work platform, the control desk being designed to enable the operator to engage a rotation of the turret, the method comprising:
implementing the first rule which comprises stopping the rotation of the turret if the rotation of the turret is in progress at the time when the detection system detects the occurrence of the risk situation for the operator, and
implementing the second rule which comprises rotating the turret at a reduced speed with respect to a normal speed of rotation of the turret if the risk situation for the operator is detected by the detection system at the time when the rotation of the turret is engaged at the control desk.

21. (canceled)

22. (canceled)

23. The method according to claim 1, wherein:
the detection system is designed to detect a risk situation for the operator on board the work platform due to the movement of the work platform, or
the detection system is designed to detect a crushing risk situation for the operator on board the work platform, the crushing risk situation being detected with respect to the body of the operator.
